(19) United States
(12) Patent Application Publication
(10) Pub. No.: US 2018/0241162 A1
(43) Pub. Date: Aug. 23, 2018

(54) ILLUMINATING DEVICE

(71) Applicant: TEN ONE DESIGN LLC, Montclair, NJ (US)

(72) Inventors: Peter James Skinner, Montclair, NJ (US); David James Skinner, Portland, OR (US)

(21) Appl. No.: 15/899,754

(22) Filed: Feb. 20, 2018

Related U.S. Application Data
(60) Provisional application No. 62/462,036, filed on Feb. 22, 2017.

(51) Int. Cl. H01R 13/717; H01R 13/66

(52) U.S. Cl. CPC H01R 13/7175; H01R 31/06; H01R 13/6641

(57) ABSTRACT

An illuminating device comprising an input stage having an antenna to receive electromagnetic fields, the input configured to condition the electromagnetic field received so as to generate an input stage output signal if an electromagnetic field signal is detected therefrom, a sensing and evaluation stage coupled to the output signal and configured to determine characteristics of the output signal so that if the determined characteristics meet at least one predefined criterion, a sensing and evaluation output signal is enabled, and an output stage coupled to the sensing and evaluation stage, the output stage including a countdown timer, the output stage controlling an illuminating element so as to energize the illuminating element to emit light when the sensing and evaluation output signal is enabled.

### CROSS REFERENCE TO RELATED APPLICATION

This application claims priority under 35 USC § 119 to U.S. Provisional Patent Application No. 62/462,036 filed on Feb. 22, 2017, whose entire contents are hereby incorporated by reference.

### TECHNICAL FIELD

The present invention relates to an illuminating device (apparatus) typically for assisting in the location of an electrical outlet.

### BACKGROUND OF THE INVENTION

There are a number of devices to assist in finding an electrical outlet. Such devices are typically associated with an electrical plug to be inserted into an electrical outlet. There are also devices to sense the presence of a voltage associated with electrical wiring, including devices for non-contact voltage testing.

### SUMMARY OF THE INVENTION

The present invention relates to an illuminating device comprising an input stage having an antenna to receive electromagnetic fields, the input configured to condition the electromagnetic field received by the antenna so as to generate an input stage output signal if an electromagnetic field signal is detected therefrom, a sensing and evaluation stage coupled to said input stage output signal, said sensing and evaluation stage configured to determine characteristics of said input stage output signal so that if the determined characteristics meet at least one predefined criterion, a sensing and evaluation output signal is enabled, and an output stage coupled to said sensing and evaluation stage, the output stage including a countdown timer, the output stage configured to control an illuminating element so as to start the countdown timer and to energize said illuminating element to emit light when said sensing and evaluation output signal is enabled, the countdown timer configured so that upon a time out of said timer, the output stage de-energizes the illuminating element.

Another embodiment of the present invention is the illuminating device as described above, wherein the predefined criterion of the sensing and evaluation stage is a range of frequencies such that if the determined characteristics of said input stage output signal is within said range of frequencies, the sensing and evaluation output signal is enabled.

Another embodiment of the present invention is the illuminating device as described above, wherein an additional predefined criterion is a range of amplitudes and wherein the sensing and evaluation stage is configured to determine if the input stage output signal is within said range of amplitudes and is within said range of frequencies, and if both criteria are met, said sensing and evaluation output signal is enabled.

Another embodiment of the present invention is the illuminating device as described above, wherein an additional predefined criterion is a rate of change of the amplitude of the input stage output signal and wherein said sensing and evaluation output signal is configured to determine if said input stage output signal is increasing at least at said predefined rate of charge and is within said range of frequencies, and if both criteria are met, said sensing and evaluation output signal is enabled.

A further embodiment of the present invention is the illuminating device as described above, wherein the sensing and evaluation stage is configured to ignore DC voltage signals associated with said input stage output signal.

A further embodiment of the present invention is the illuminating device as described above, wherein the countdown timer is implemented with digital circuitry.

Another embodiment of the present invention is the illuminating device as described above, wherein the countdown timer is configured with analog circuitry.

Another embodiment of the present invention is the illuminating device as described above, wherein the input stage generates a wake signal if an electromagnetic field signal is detected, wherein the sensing and evaluation stage has a low power state and high power state, the sensing and evaluation stage configured to transition from the low power state to the high power state upon sensing the wake signal is generated by the input stage and maintaining said high power state while determining the characteristics of said input stage output signal and returning to the low power state after said characteristics of said input stage output signal are determined.

A further embodiment of the present invention is the illuminating device as described above, wherein the output stage has a low power state and a high power state, the output stage configured to transition from the low power state to the high power state when the sensing and evaluation output signal is enabled and to transition to the low power state when the countdown timer times out.

A further embodiment of the present invention is the illuminating device as described above, wherein the illuminating device is housed in an electrical plug and wherein the output stage is configured to de-energize the illuminating element if the illuminating device is plugged into an electrical outlet.

Another embodiment of the present invention is the illuminating device as described above, wherein the antenna is a prong of an electrical plug.

Another embodiment of the present invention is the illuminating device as described above, wherein the output stage is configured to de-energize the illuminating element if the electrical plug is plugged into an electrical outlet.

Another embodiment of the present invention is the illuminating device as described above, wherein the illuminating device is powered by a battery.

A further embodiment of the present invention is the illuminating device as described above, wherein the illuminating device includes a grounding node to establish an electrical reference potential.

A further embodiment of the present invention is the illuminating device as described above, wherein the grounding node is an electrical conductor of an electrical plug within which the illuminating device is housed.

Another embodiment of the present invention is the illuminating device as described above, comprising an input circuit configured to sense an ambient electromagnetic field, said input circuit upon sensing an ambient electromagnetic field configured to generate an amplified AC voltage and a first output signal, a signal discriminator coupled to said amplified AC voltage and said first output signal, said signal discriminator having an active state and an inactive state, said signal discriminator configured to transition from the inactive state to the active state upon receipt of said first output signal and when in said active state configured to determine characteristics of said AC voltage so that if the determined characteristics meet a predefined criterion, a second output signal is enabled and a drive circuit coupled to said second output signal, the drive circuit configured to control an illuminating device so as to cause said illuminating device to emit light when said second output signal is enabled.

### BRIEF DESCRIPTION OF THE DRAWINGS

FIG. 1 is a block diagram of the illuminating device.

FIG. 2 is a flow chart showing the operation of the illuminating device.

FIG. 3 is an exploded perspective view showing the illuminating device housed in an electrical plug.

FIG. 4 is a perspective view of the plug with the illuminating device housed therein.

FIG. 5 is an electrical schematic of an embodiment of the illuminating device.

FIG. 6 is an electrical schematic diagram of another embodiment of the illuminating device.

FIG. 7 is an electrical schematic diagram of a further embodiment of the illuminating device.

FIG. 8 is a block diagram of another embodiment of the illuminating device having an analog frequency to voltage converter.

FIG. 9 is a flow chart with respect to signal discrimination.

### DETAILED DESCRIPTION

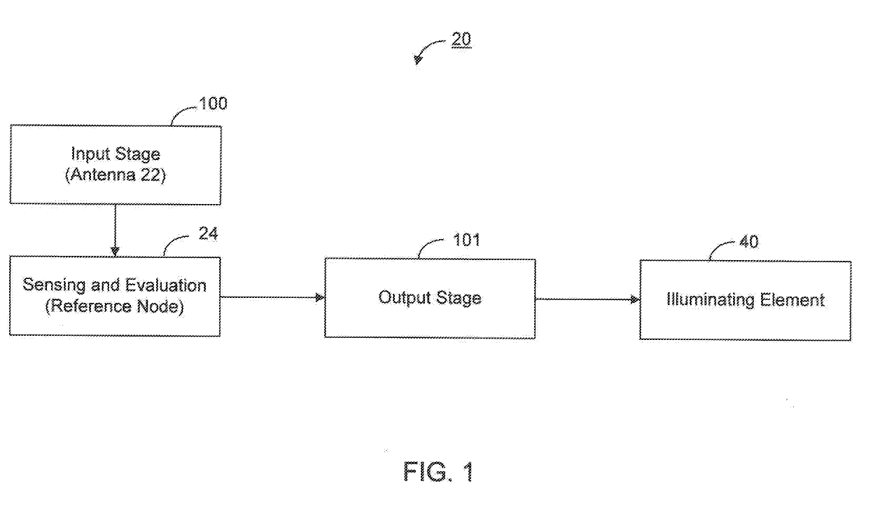

As seen in FIG. 1, an illuminating device 20 according to the present invention comprises three stages or components; namely, an input stage 100, including antenna 22; a sensing and evaluation module 24, including a grounding node 26; and an illuminating element (e.g., an LED) 40.

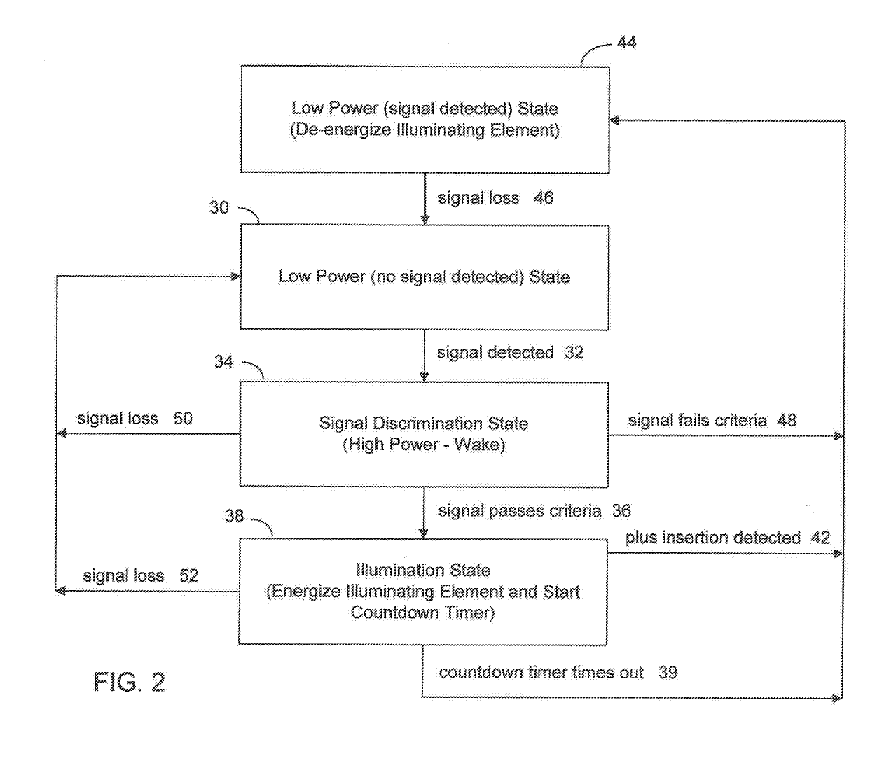

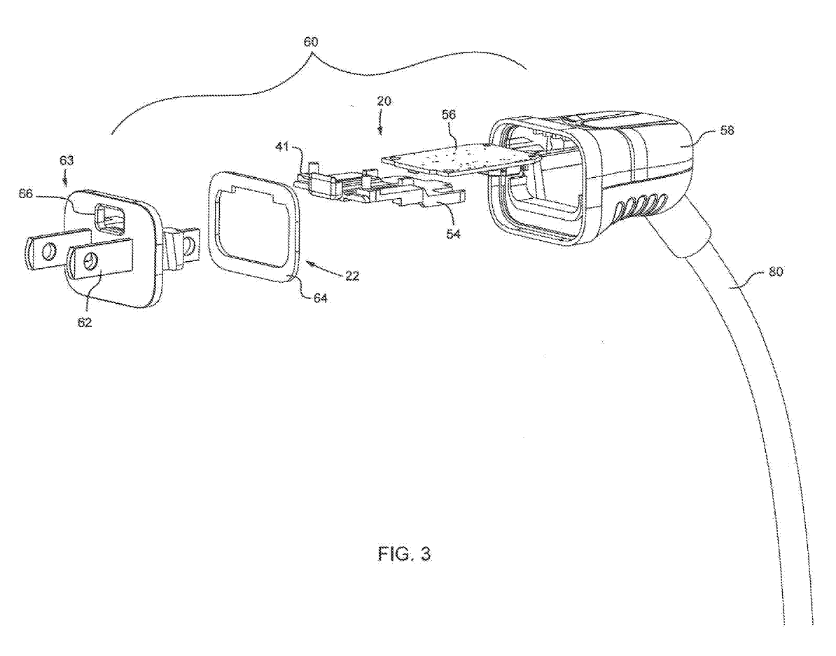

FIG. 2 is a flow chart showing the operation of the illuminating device. Thus, when activated it is typically in a Low Power (no signal detected) State 30, where the antenna, and the circuitry associated therewith, has not sensed a signal associated with an alternating current (AC) electrical outlet. Such a signal is typically an electromagnetic signal associated with 60 cycle alternating current. If a signal is detected by the illuminating device (signal detected event 32), the device transitions to a Signal Discrimination State 34. In this state, if characteristics of the detected signal meet at least one predetermined criterion (signal passes criteria event 36), the illuminating device transitions to the Illumination State 38. When the device transitions to the Illumination State, a countdown timer (discussed below) is activated and an illuminating element 40 (such as an LED) is energized (see FIGS. 3 and 5-8), thereby providing illumination to the user so as to find an electrical outlet, and thereby assisting in insertion of the electrical plug into the electrical outlet. The illumination device remains in the illumination state until the countdown timer times out (countdown timer times out event 39), at which time the illumination device transitions to a Low Power (signal detected) State 44, which de-energizes the illuminating element. The illuminating device remains in the Low Power (signal detected) State until a signal loss event 46 occurs, at which time the illumination device transitions back to the Low Power (no signal detected) State 30.

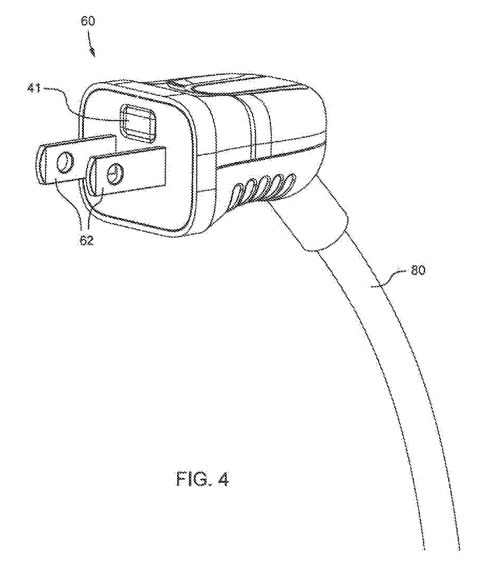

The illuminating device can optionally transition to the Low Power (signal detected) State 44 when an electrical plug 60 (see FIGS. 3 and 4) associated with the illuminating device is plugged into an electrical outlet (plug insertion detection event 42).

As seen in FIG. 2, when in the Signal Discrimination State 34, the illumination device transitions to the Low Power (signal detected) State 44 if the signal fails to meet at least one criteria (signal fails criteria event 48). Also, when in the Signal Discrimination State, if the signal is lost (signal loss event 50), the illumination device transitions to the Low Power (no signal detected) State 30 where it will remain until a signal detected event 32 occurs.

Similarly, when in the Illumination State 38, if a signal loss event 52 occurs before the countdown timer times out, the illumination device transitions to the Lower Power (no signal detected) State 30, which can optionally de-energize the illumination element before the countdown timer times out. The illuminating device remains in this state until a signal detected event is detected.

Thus, in operation, the illumination device in the absence of sensing a signal associated with an AC electrical outlet, will be in the Low Power (no signal detected) State 30 and the illuminating element (LED) is not energized. When a signal is detected and the signal passes at least one criterion, as more fully explained below, the illumination device illuminates the LED for a period of time. The illumination thus assists a user of the device to insert an electrical plug associated therewith into the electrical outlet.

Details of State Diagram Elements (FIG. 2)

Low Power (Signal Detected) State 44

The illuminating device is in a low power state, and a signal of some kind has been detected. The device cannot transition to a non-low power state (called wake or high power) until the signal is first lost. This is the state that the device is in after the illuminating element (LED) has been illuminated (see below). When the signal is lost, the device transitions to Low Power (no signal detected) State 30.

Low Power (No Signal Detected) State 30

In this state the device will wake on any signal detected event 32 and transition to the Signal Discrimination State 34.

Signal Discrimination State 34

Although a signal is detected, it must be evaluated to determine if the illuminating element should be energized. For example, if an electrical potential gradient is detected, but it is not of the correct frequency associated with an AC electrical outlet, the illuminating element should not be energized, and the circuit should return to a low power state.

The signal may be measured by comparing its characteristics with a desired signal type. These characteristics may include the signal frequency content, amplitude, duration, signal to noise ratio, jitter, modulation, etc. Signal discrimination may also consider how any of these characteristics change over time.

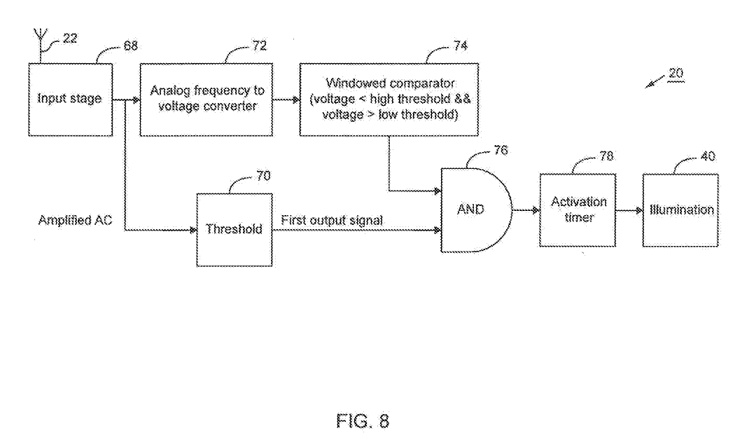

Known signal processing and measuring techniques may be used to perform the signal measurement, including analog to digital converters, comparators, mixers, demodulators, and frequency counters (for example, see modules 72 and 74 of FIG. 8).

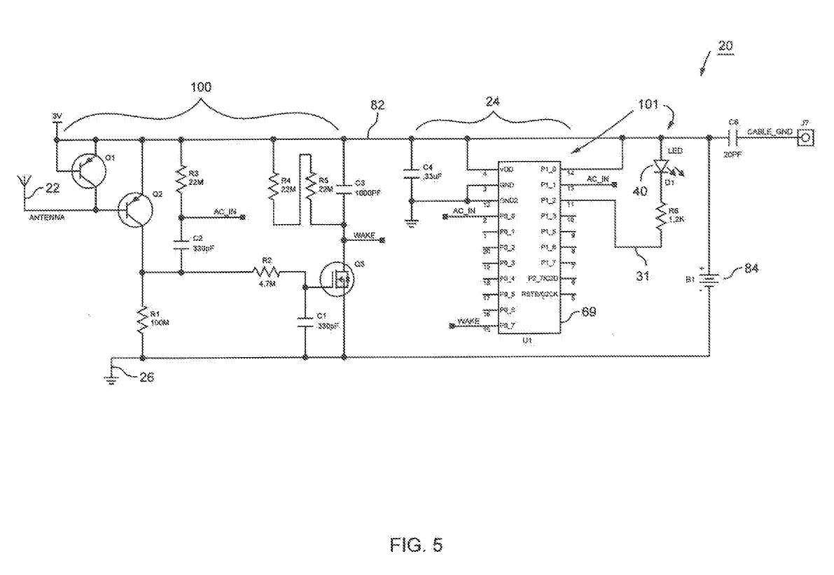

If the device is battery powered (see battery 84, FIGS. 5-7) or is otherwise power constrained, a preferred signal measurement technique will consume a small amount of power while still providing useful measurement data for performing discrimination.

Once the signal has been measured, the sensing and evaluation stage 24 (e.g., see FIGS. 5-7) determines if the measurements meet at least one criterion for activation. One criterion can be a signal with a consistent frequency within a range of frequencies, and with an amplitude within a range of amplitudes. Another criterion can be a signal with a quickly increasing amplitude, suggesting the device may be moving quickly within the electrical potential gradient toward a signal source. On the other hand if the signal is changing slowly, it may indicate only slowly changing ambient voltage levels that are not associated with an intentional user movement. Another discrimination strategy component is to ignore high DC voltages signals such as those created by static electricity accumulation.

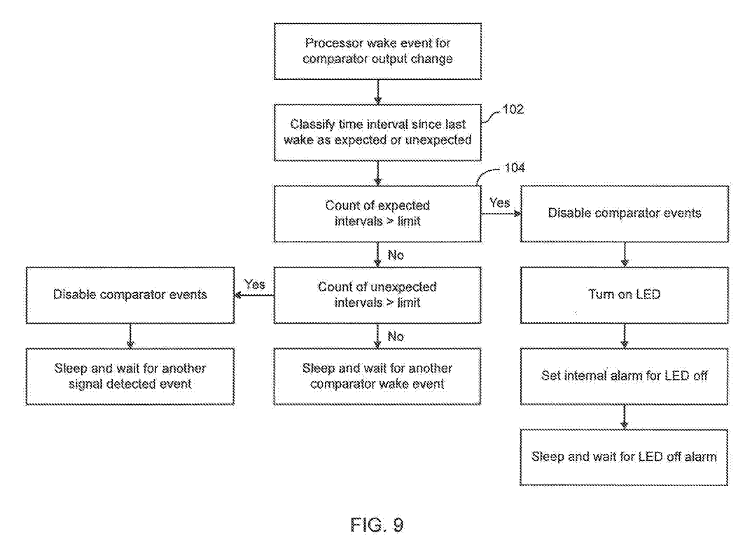

FIG. 9 is a flow chart illustrating the steps that can be used for the signal discrimination state. As shown in FIG. 9, a digital processor associated with integrated circuit 69 can be used for signal discrimination. For example, the wake event (wake signal ON) can be used to determine when to wake the processor associated with integrated circuit 69. Thus, the time intervals between wake events can be used in association with the processor to determine if the input signal from input stage 100 meets a predetermined criteria. FIG. 9 illustrates such a software discrimination flow chart which shows how the software in the digital processor associated with integrated circuit 69 determines if a signal discrimination state has been met. Step 102 compares the measured time intervals since the last wake event occurred against a range of time intervals and determines if the wake event is expected; that is, within a particular time interval. For example, for a 60 hertz AC signal, a wake event should occur every 8.33 milliseconds (one for the positive transition and one for the negative transition of the AC signal). The 8.33 millisecond time period can be compared with a range of acceptable time periods, such as between 5-11 milliseconds. Thus, if a wake event is sensed within such a range of time intervals, it can be classified as an expected wake event and the expected interval counter is thus increased by 1 (see step 104). If the number of expected intervals exceeds a predetermined number (such as 4), then the limit number for step 104 is exceeded (answer YES) and therefore the LED is energized. Of course, a number of counts need not be 4, but any number which would be indicative of a sufficient number of wake events within the expected time interval range which would be indicative of the presence of an AC signal. Further description concerning integrated circuit 69 is presented in the section entitled “Output Stage 101”, below.

Criteria evaluation may be accomplished with a fully analog circuit, a fully digital circuit, or a combination of both analog and digital circuitry. In one embodiment, analog circuitry conditions a signal and converts polarity changes into digital state transitions for a digital processor to evaluate (see FIG. 8). In another embodiment, analog circuits sensitive to a limited range of frequencies are used to detect the presence of a signal within a band or plurality of bands. A combination of these frequency band detectors may be used with analog switches and timing circuitry to establish if a given signal passes a given criteria. In yet another embodiment, the incoming signal is sampled at a high frequency and the resulting discrete signal data is processed by a digital processor and determine an outcome based on criteria.

If the device is battery powered or is otherwise power constrained, a preferred signal discrimination technique will quickly decide an outcome and allow the device to return to one of the low power states (see FIG. 2) depending upon the outcome of the Signal Discriminator State.

If a signal loss event 46 occurs (FIG. 2), the device will return to Low Power (no signal detected) State 30. If the signal does not meet the criteria (event 48), the device will also transition to Low Power (signal detected) State 30.

Illumination State 38

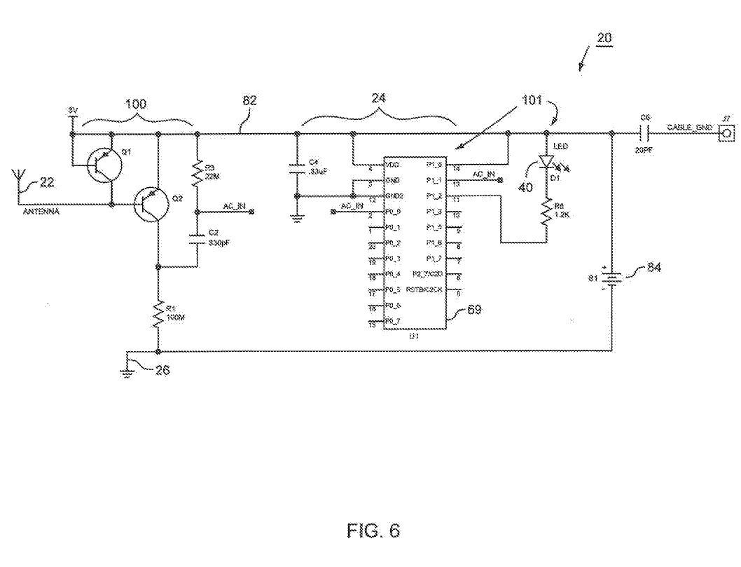

The duration of illumination element energization is finite in a power constrained design (FIGS. 5 and 6 for example). If the signal is lost, the device will return to Low Power (no signal detected) State 30. Otherwise it will stay in the Illumination State for a period of time and then transition to Low Power (signal detected) State 44 when a countdown timer times out (event 39).

In some embodiments it may be desirable to immediately de-energize the illuminating element 40 if plug insertion is detected. Thus, if insertion is detected (event 42), the device may transition immediately to Low Power (signal detected) State 44. Plug insertion detection may be accomplished by directly or indirectly sensing the voltage or current in the conductors connected to the prongs. The voltage of one or more conductors may be detected by establishing an electrical path to the conductor directly or through a capacitance or resistance. Alternately, the antenna or a secondary antenna (not shown) may be employed to sense the change in the voltage field created by the sudden electrification of the conductors connected to the prongs. Detection may also be achieved by sensing current flow in the conductors of the illuminating device. In this case, the conductors must be arranged in such a way as to provide mutual inductance with some magnetic field detection circuitry. Still another method of detection may be achieved by attempting to pass a small current between conductors. Current flow and subsequent detection will occur when the prongs are connected to an electrical system that provides a conduction path. In common three-prong systems, the neutral conductor is connected to the ground conductor at the electrical breaker box and the electrical conduction path may be used for this purpose. Finally, the illumination may naturally extinguish if the electrification of the conductors causes a similar electrical field potential at the antenna and grounding node. This condition would result in a transition to Low Power (no signal detected) State 30.

Additional techniques to determine plug insertion detection are:

1) An electrical switch with a mechanical actuator depressed by contact with the outlet or another physical body.

2) Other known proximity detection techniques such as radar, sonar, or a photodiode may be used to determine if a surface is within a certain distance from the plug face.

As seen in FIG. 3, the illumination device 20 can be housed on a printed circuit board (PCB) 56 which can be secured to a plastic member 54 to provide structural support to PCB 56. This member may be made from a clear plastic material. The PCB holds a battery 84 (see FIGS. 5-7), circuit components (see FIGS. 5-7) and the illuminating element (LED) 40. In an embodiment of the invention, the components are mounted on the underside of PCB 56 while LED 40 is mounted near an edge of the PCB, pointed toward the front of the device. Member 54 can also have a lens 41 mounted thereto to adjust the light beam emanating from illuminating element 40. PCB 56 and member 54 are inserted within an electrical plug housing 58. The overall electrical plug 60 also has electrical prongs 62 passing through a non-conductive wall 63. A conductive foam member 64 can act as an antenna 22 for device 20. Member 64 is pressed against the PCB when plug 60 is assembled. Non-conductive wall 63 includes a window 66 for receipt of lens 41.

FIG. 4 shows the electrical plug in its assembled configuration.

FIGS. 5-7 show schematics for three embodiments of the present invention as described below.

Input Stage 100 (FIGS. 1 and 3-6)

As seen in FIGS. 1, 5-7, an antenna 22 is associated with input stage 100. The antenna senses (receives) electromagnetic fields and thus the electromagnetic field gradient (i.e., change in the electromagnetic field) as the illumination device is moved relative to a source of electromagnetic energy, such as that associated with an AC outlet. It has been noted that a variety of antenna geometries may be used. In general, a larger surface area of an antenna facing the electrical outlet (receptacle) provides greater capacitive coupling to the AC signal source and therefore improves the sensitivity of the illumination device.

Although a very large antenna will result in increased sensitivity, it may result in more accidental circuit activations, therefore consuming power unnecessarily. A large antenna may also be difficult to physically mount in an electrical plug small enough for typical use. A large plug size can often block adjacent receptacles in a power tap or multi-gang style power outlet.

The antenna is positioned in the illuminating device so as to be physically separated from locations that serve to attenuate the electrical field. As seen in FIGS. 3 and 4, prongs 62 of the device extend some distance from the electrical plug housing 58. The prongs may be connected to conductors that extend near more grounded areas of the electric field gradient and one or more prongs may be grounded. In such cases, at least some of the prongs may act to attenuate the electrical field in the area around the face of the plug. As seen in FIG. 3, the foam 64 when used as the antenna 22 is located near the face of the plug and is constructed to reduce capacitive coupling with prongs 62 or other grounded objects.

It should be noted that an unused prong of electrical plug 60 may be used as an antenna. For example, if an application requires only a two-conductor power connection (line+neutral), the third prong (typically a ground) may be used as an antenna. Such a protruding antenna geometry may provide benefits to device sensitivity.

The input stage conditions the electromagnetic field signal received from antenna 22 and generates an output signal (AC IN, see e.g., FIGS. 5-7) for presentation to the sensing and evaluation stage 24. The input also generates a wake signal if an electromagnetic field signal is detected by the input stage (signal detected event 32—see FIG. 2).

Sensing and Evaluation Stage 24 (FIGS. 1 and 5-7)

This stage evaluates the signal from the input stage and determines if the illuminating device should be energized.

Techniques for evaluation are discussed in the signal discrimination portion of the state diagram.

An electrical reference node forms part of the sensing and evaluation state 24. This node can be the 3V power rail 82 or grounding node 26. Either the 3V rail or the grounding node can be used as a reference node so as to establish a reference for the circuitry shown in FIGS. 5-7. When activation is desired, it is at a potential dissimilar from the potential in close proximity to the electrical outlet. Thus, the illumination device can detect the voltage gradient and determine if one or more criteria are detected to transition to Illumination State 38 (FIG. 2). In other embodiments, a circuit ground may be used as a reference node. Some other reference voltage could be used if desired.

For a grounding node 26, the positioning of the node at an appropriate potential can be challenging. In some situations, it can be advantageous to provide an electrical path to the user of the plug. The path impedance can be largely resistive, largely capacitive, or a combination of both. When the user of the plug is not in contact with the plug body, the grounding effect may be reduced and the sensitivity of the device may decrease. This can be a desired behavior that helps prevent accidental activation of the device when not held by the user.

Another grounding strategy is to provide an electrical path to one or more conductors in a cord 80 (see FIGS. 3 and 4) connected to the plug. An attached conductor may be principally used for another purpose or for the sole purpose of grounding the device. The conductor may also comprise a shield for the cable. A small diameter dedicated conductor may be warranted when the other conductors are not suitable for use as a grounding connection and minimal impact to cable size and flexibility is desired.

When grounding through a cable conductor, the voltage potential of the ground is determined by the location of the cable in the electromagnetic voltage gradient surrounding the electrical outlet. In practice, the natural position of the cable is often sufficiently removed from the voltage field source and provides a suitable ground. Using this grounding method prevents an issue with other conductors in the same cable transferring a voltage potential from another location in the voltage gradient to the area near the antenna node thus activating the circuit at unexpected times.

In some embodiments, it may be advantageous to use a combination of an electrical path to the user and an electrical path to one or more cable conductors to provide a ground potential referenced to geometry that occupies a relatively large volume and is positioned at a potential different from that of the antenna electrode.

Illuminating Element 40 (FIGS. 1, 3, and 5-7)

Illuminating element 40 is typically an energy efficient element such as one or more light emitting diodes 40. The illumination is generally directed towards the area of interaction between the electrical plug and the outlet (see window 66—FIG. 3). The illumination is bright enough to remove ambiguity about the location and orientation of the electrical outlet. If the LED is near a plug face, the light pattern striking the electrical outlet may be interrupted by shadows from prongs or other nearby objects. Other locations are possible for the illuminating element. The areas of the electrical outlet affected by the shadow will be less visible to the user and reduce the ease with which the plug can be inserted. These shadows can be reduced by increasing the size of the illumination surface. For example, if a single LED is used as the illuminating element, it may cast relatively sharp shadows. In this case a lens 41 may be placed in optical alignment with the LED, the lens having light diffusing properties. The lens serves to increase the size of the light beam and softens and reduces the impact of shadows. In another embodiment, LEDs 40 may be mounted around the perimeter of the plug face (not shown) to nearly eliminate any difference in illumination created by prongs over the surface of the outlet.

Electrical Schematics of Embodiments (FIGS. 5-7)

FIG. 5 is an electrical schematic for one embodiment of the present invention. As described more fully below, it encompasses an input stage 100, including transistors Q1-Q3, resistors R1-R5 and capacitors C1-C3. It also includes a sensing and evaluation stage 24 including integrated circuit 69 (U1—e.g., Silicon Labs EFM8SB1 series processor) and capacitor C4. An output stage 101, including illuminating element 40, also includes integrated circuit 69, as well as diode D1 and resistor R6. Passive component values are shown in FIGS. 5-7. Table 1 provides information regarding the active components.

Input Stage 100 (Q1,2,3, R1,2,3,4,5, C1,2,3)
Q1,Q2,R1 Input transistors Q1 and Q2 have extremely low capacitance. PNP transistor Q2 performs a current gain, and Q1 has a small bias current keeping Q2 in the off state when no signal is present. The output current is seen as a voltage on R1. At this point the voltage generally has a frequency component similar to the frequency of the input current (e.g., 60 cycles). Antenna 22, and thus any electromagnetic field detected by the antenna, is coupled to transistors Q1 and Q2 as shown.
C2,R3, Capacitor C2 couples the small amount of AC current from the collector of Q2. The current creates a small AC voltage centered about the device's top rail 82 by R3. This small AC voltage is ultimately used for signal discrimination.
C1,R2,Q3,R4,R5, C3 The output of Q2 passes through a low-pass filter comprising R2 and C1, and appears at the gate of MOSFET Q3. Q3 performs a voltage gain by pulling current through series connected R4 and R5 (two resistors may be used for cost saving reasons). C3 reduces the ripple voltage at the drain of Q3. This voltage behaves similarly to a digital logic level and is used to wake processor U1 from a sleep mode.

An input stage output signal (AC IN) is the conditioned signal received from antenna. Wake point 29 is activated upon electromagnetic field signal detection, which activates the sensing and evaluation stage 24 (see below).
Notes on power usage: The input stage typically uses a maximum of 100 nA, and significantly less current when no signal is present.

Sensing and Evaluation Stage 24 (U1,C5,C6)
Wake function Port 0_7 (pin 15) is configured to wake processor 69 (U1) from its low power state. A falling edge will wake the processor, and a rising edge will indicate signal loss. These edge events are suitable for use as “signal detected event 32” and “signal loss event 46” transitions (events) in the state diagram (FIG. 2). Upon awakening, the processor (69) enables the comparator and an integrated real time clock, then returns to sleep. C4 is used as a decoupling capacitor.
Signal timing measurement Port 1_1 (pin 13) is configured as an analog comparator. It compares the signal against the circuit power rail 82 (3v). It is configured to wake the processor upon a compare edge, and is capable of adding a configured amount of hysteresis to reduce unwanted noise from the output. A suitably strong 60 Hz signal from a nearby outlet will cause a wake event about two times every 16 ms. When the processor awakens (wakes), it uses an internal real time clock to measure the time since the last wake event, and returns to sleep. The timing information can be used to make signal discrimination decisions.
Signal discrimination using timing information. Each time the processor awakens for a compare event, it evaluates the last received timing information against a criteria. The criteria comparison is implemented in software. One typical criteria for this implementation (effective for a range of 46 Hz to 72 Hz):

1) Each interval received must be greater than 3 ms and less than 19 ms.

2) Each consecutive sum of two intervals must be greater than 14 ms and less than 23 ms.

3) The first two intervals received are considered acceptable regardless of their size.

4) Seven acceptable intervals must be received within 100 ms of the initial “signal detected” wake event 32, and before 10 unacceptable intervals are received.

This criteria is able to handle idiosyncrasies that may be associated with the input stage, including an asymmetric and distorted voltage appearing at the compare input.

If the signal passes the signal discrimination, a sensing and evaluation output signal 31 is generated (see below).
Notes on power usage: Processor 69 consumes about 50 nA when in a low power mode. Although power consumption is higher when awake (Signal Discrimination State 34 and Illumination State 38), integrated circuit 69 is only awake for short periods of time before returning to sleep (low power, see Low Power (signal detected) State 44 and Low Power (no signal detected) State 30. Therefore the power overhead for employing integrated circuit 69 as a signal discriminator is very low.

Integrated circuit 69 includes a watchdog timer that is started by the integrated circuit when the integrated circuit determines that the signal passes the signal discrimination criteria.

Output Stage 101 (69,D1,R6)

(D1,R6) Port 1_2 (pin 11) of integration circuit 69 is configured to drive current through diode D1. This causes energizing of illuminating element 40. The output can be a pulse width modulated or steady DC. The illumination element current can vary with the rail voltage (e.g., 3V DC on rail 82), causing more illumination when the battery is fresh and a lower illumination when the battery 84 is lower. Other illumination devices (such as electroluminescent panels—ELs—and organic LEDs—OLED's) are possible, as are methods to generate a constant illumination independent of the battery voltage. The output stage is de-energized when the countdown timer (U1) times out (event 39). The output stage may optionally also be de-energized if plug insertion is detected (event 42).

The illuminating element is energized for a period of time, typically set by a countdown timer executed within processor 69. Other techniques can be used to maintain energization of the illuminating element for a period of time, such as a voltage associated with a resistor-capacitor circuit (charging or discharging of a capacitor via a resistor, for example, not shown). The use of the term “countdown timer” embraces such alternative techniques known in the art.

Grounding
C6 is used to connect the circuit rail 82 to the conductor in an attached cable. This serves to ground the circuit to a suitable voltage in the electrical potential gradient. Note that this implementation uses the supply rail as the reference node, and can therefore be treated as a traditional ground.

Battery 84 can be a “coin” type battery (e.g., lithium CR2032) which has a long shelf life (typically ten years). In another embodiment, a rechargeable battery with associated charging circuit may be used instead of battery 84. The charging circuitry is powered when the device (mounted in a plug) is energized by the AC of the outlet in which the plug is inserted.

FIG. 6 is a schematic diagram of another embodiment of the illumination device. In this embodiment, the circuitry is basically the same as that shown in FIG. 5, except that this embodiment does not have mosfet transistor Q3 and its associated passive elements. In this embodiment the amplified AC voltage is only fed to a comparator. The comparator output (AC IN) serves to awaken processor 69 and to provide it with digital pulses that correspond to the frequency of the input signal. This embodiment of the illumination device is slightly less power efficient as compared to the embodiment shown in FIG. 5 since it awakens the processor every once in a while and checks if the output signal is no longer present. This requires keeping an oscillator powered as a timer for the duration of time that a signal is present. Thus, this embodiment eliminates the first output signal associated with the embodiment shown in FIG. 5.

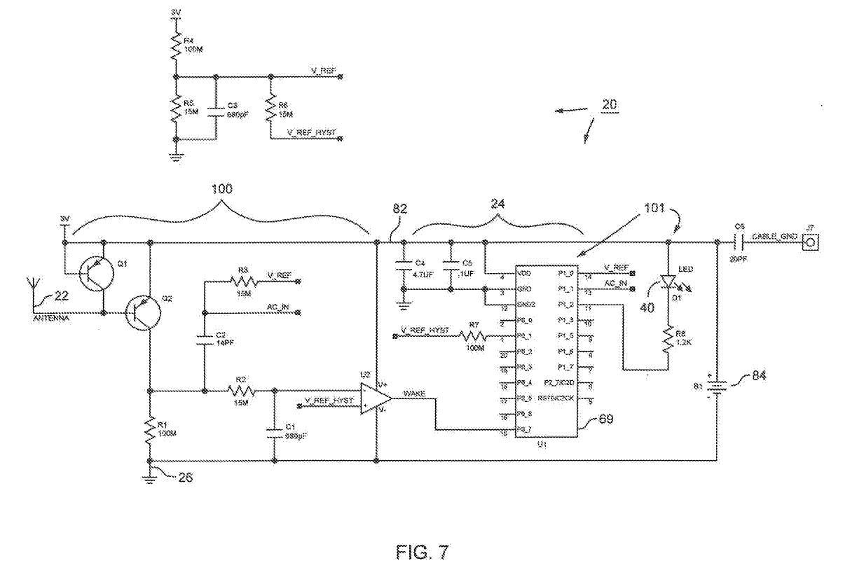

FIG. 7 is a schematic diagram of a further embodiment of the illumination device. In this embodiment, a comparator U2 (part number TLV3691) is used to replace transistor Q3, capacitor C3 and resistors R4 and R5 for purposes of determining a threshold at which the processor 69 will awaken and begin evaluating pulses from the input circuit 100. The processor can also dynamically alter the threshold by changing P0_1 from a high impedance state to a logic 0 output. This creates a hysteresis effect at the U2 comparator, thereby increasing the stability of the wake transition.

In the embodiments shown in FIGS. 5 and 6, the illuminating device can use the 3V rail 82 as a reference for the internal comparator at P1_0. In the embodiment shown in FIG. 7, a new node V_REF is used. This embodiment improves performance by isolating the reference from transient variances at the 3V rail 82.

The V_REF node is also used as the threshold level for integrated circuit U2.

Bypass capacitor C4 value is different from the embodiment shown in FIGS. 5 and 6, while capacitor C5 is added as a secondary bypass capacitor.

The embodiment shown in FIG. 7 can improve system performance, otherwise the architecture is substantially the same as that for the embodiment shown in FIGS. 5 and 6.

FIG. 8 is a block diagram of the another embodiment of an illumination device which includes an analog frequency to voltage converter 72. As seen there, it includes an antenna 22, an input stage 68, a threshold module 70, an analog frequency to voltage converter 72, a threshold detector module 74, a logic gate 76, an activation timer 78 and an illumination element 40.

Input Stage 68

The purpose of this stage is to amplify signals from antenna 22 and present the signals to the next two stages 70 and 72. The input stage has a high impedance input connected to antenna 22, as well as low power consumption.

Threshold 70

This stage compares the amplitude of the amplified AC signal against a specified level and outputs a higher voltage level if the amplitude is greater than the specified level (first output signal).

Analog Frequency to Voltage Converter 72

This stage outputs a low voltage when a low frequency signal is detected, and an increasingly higher voltage for inputs of higher frequency.

Windowed Comparator (Voltage<High Threshold and Voltage>Low Threshold) 74

This stage compares the output voltage of the analog frequency to voltage converter 72 against two voltage levels, one low level and one high level. If the input voltage is between these two levels, the output is a high voltage to AND gate 76. Otherwise, the input is low.

And Gate 76

This gate has an output which is high if both inputs to the AND gate are high. Otherwise, the output is low.

Activation Timer 78

Upon receiving a high input, this timer outputs a high voltage for a period of time so as to energize the illuminating element 40, after which time the output of the activation timer is low so as to deenergize the illuminating element. The activation timer will immediately go to a low voltage if the output of the AND gate becomes low.

Illumination Stage Associated with Illuminating Element 40

This stage (illuminating element 40) generates light when it receives energization from the activation timer.

### Variation of Embodiments

It is noted that illumination device 40 may have various embodiments, including: A device integrated into an electrical plug (see FIGS. 3 and 4). The plug may be corded or attached directly to the device consuming the power.

A device attached without electrical contact to another device, for example disposed against the top side of a corded plug and affixed with an elastic strap (not shown).

A device electrically attached to the prongs of an existing plug as an adapter (not shown).

A device integrated into another device that provides one or more functions (not shown). These functions may include surge protection, a power tap, an adapter to allow interconnection of devices with differing prong configurations, power conversion such as from AC power to DC power, or from one voltage amplitude to another.

Thus, what has been described and shown is an illumination device to assist in finding an electrical outlet by energizing an illuminating element (LED) when a plug is in the vicinity of an electrical outlet.

Discussion of Electric Field Variability

Electrical field gradients near electrical outlets can be complex. If the gradient is generated by a single point surrounded by a material with a constant electrical permittivity, the illumination device would have relatively little difficulty inferring the proximity of such a point. However, electrical outlets and their surrounding structures are often a cornucopia of disruption and variability, creating challenges that the device must overcome to infer electrical outlet proximity.

Electrical outlets are often installed into earth-grounded metal box enclosures. These enclosures create surrounding surface geometries of zero potential. The attenuation effect of a metal box with one or more open sides is directional in nature. The electrical field gradient protruding from the box is greater near any open sides.

The electrical outlet may have a metal face plate that may attenuate an electrical voltage field gradient as it is typically electrically grounded with a mounting screw. The face plate attenuation is directional in nature and is effective in reducing the voltage field in the areas directly in front of the outlet.

Outlets contain a variety of internal conductor geometries. As such, an outlet from a first manufacturer may create a voltage gradient that differs from an outlet from a second manufacturer, even though the outlets have a similar exterior appearance and advertised features. Other outlets types are configured to perform specific tasks such as ground fault circuit interruption (GFCI), arc fault circuit interrupter (AFCI), increased voltage or current capacity, and increased terminal retention capability such as for ‘hospital grade’ outlets. Power receptacles designated for other uses are also considered, such as receptacles that provide power to electric vehicles or industrial equipment.

Nearby conductive, semi conductive, or static dissipative geometries can influence the shape and strength of a voltage gradient surrounding an electrical outlet. Examples of objects commonly located near an electrical outlet include metal conduits, metal pipes for transporting fluids, steel building structural elements, equipment or cords connected to adjacent outlets or nearby electrical outlets, outlets of other types such as RJ-45, RJ-11, or coaxial connectors, power strips or wiring operative to service nearby equipment, equipment mounting racks such as those used to mount equipment modules such as computer servers, nearby metal objects such as tables or chairs, and other objects that may have electrical properties. In addition to these types of objects, nearby objects that are not commonly perceived as conductive may alter the shape and strength of an electrical gradient if they have static dissipative properties by design or as a result of surface contamination, high relative humidity, or other factors that may increase electron mobility over the surface or through the volume of a nearby object.

Nearby incidental voltage sources can alter the shape and strength of a voltage gradient surrounding an electrical outlet, for example electrical wires passing behind walls.

Nearby triboelectric charges can accumulate as the result of friction within the device, between the device and surrounding objects, or between surrounding objects. These triboelectric charges change the shape and amplitude of the surrounding electrical potential gradient and are often transient in nature.

Static electricity accumulation on the device or nearby objects can affect the shape and amplitude of the surrounding electrical potential gradient.

Discussion Concerning Overcoming Electrical Field Variability

Although the causes of electrical field variability discussed above can alter an electrical field gradient, reasonable observations are presented below.

Thus, electrical outlets and surrounding geometries can vary widely, but as a general rule, an electrical field strength is greater near an electrical outlet.

The electrical field gradient generally contains frequency content consistent with electrical system of the electrical outlet. For example, in the United States, the electrical field would have a dominant frequency of 60 Hz.

The electrical field gradient created by static electricity accumulation is usually of a static nature.

The electrical field gradient created by triboelectric charge generation are generally of a high frequency and short duration.

Nearby incidental voltage sources are often of lower electrical potential and may often be disregarded.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

TABLE 1

| REF | PART NUMBER | ACTIVE COMPONENTS DESCRIPTION | MANUFACTURER |
|---|---|---|---|
| U1(69) | EFM8SB10F2G-A-QFN20R | CIP-51 8051 Sleepy Bee Microcontroller IC | Texas Instruments |
| | | 8-Bit 5 MHz 2KE (3 × 3) | |
| Q1, Q2 | MMBTH81 | TRANSISTOR RF PNP SOT-23 | Fairchild Semiconductor |
| Q3 | SSH3X15AFS | | |
| U2 | TLV3691 | Comparator General Purpose Push-Pull | STMicroelectronics |
| | | SC-70-5 | |

What is claimed is:

1. An illuminating device comprising:
an input stage having an antenna to receive electromagnetic fields, the input configured to condition the electromagnetic field received by the antenna so as to generate an input stage output signal if an electromagnetic field signal is detected therefrom;
a sensing and evaluation stage coupled to said input stage output signal, said sensing and evaluation stage configured to determine characteristics of said input stage output signal so that if the determined characteristics meet at least one predefined criterion, a sensing and evaluation output signal is enabled; and
an output stage coupled to said sensing and evaluation stage, the output stage including a countdown timer, the output stage configured to control an illuminating element so as to start the countdown timer and to energize said illuminating element to emit light when said sensing and evaluation output signal is enabled, the countdown timer configured so that upon a time out of said timer, the output stage de-energizes the illuminating element.

2. The illuminating device according to claim 1, wherein the predefined criterion of the sensing and evaluation stage is a range of frequencies such that if the determined characteristics of said input stage output signal is within said range of frequencies, the sensing and evaluation output signal is enabled.

3. The illuminating device according to claim 2, wherein an additional predefined criterion is a range of amplitudes and wherein the sensing and evaluation stage is configured to determine if the input stage output signal is within said range of amplitudes and is within said range of frequencies, and if both criteria are met, said sensing and evaluation output signal is enabled.

4. The illuminating device according to claim 2, wherein an additional predefined criterion is a rate of change of the amplitude of the input stage output signal and wherein said sensing and evaluation output signal is configured to determine if said input stage output signal is increasing at least at said predefined rate of charge and is within said range of frequencies, and if both criteria are met, said sensing and evaluation output signal is enabled.

5. The illuminating device according to claim 2, wherein the sensing and evaluation stage is configured to ignore DC voltage signals associated with said input stage output signal.

6. The illuminating device according to claim 1, wherein the countdown timer is implemented with digital circuitry.

7. The illuminating device according to claim 1, wherein the countdown timer is configured with analog circuitry.

8. The illuminating device according to claim 1, wherein the input stage generates a wake signal if an electromagnetic field signal is detected, wherein the sensing and evaluation stage has a low power state and high power state, the sensing and evaluation stage configured to transition from the low power state to the high power state upon sensing the wake signal is generated by the input stage and maintaining said high power state while determining the characteristics of said input stage output signal and returning to the low power state after said characteristics of said input stage output signal are determined.

9. The Illuminating device according to claim 8, wherein the output stage has a low power state and a high power state, the output stage configured to transition from the low power state to the high power state when the sensing and evaluation output signal is enabled and to transition to the low power state when the countdown timer times out.

10. The illuminating device according to claim 1, wherein the illuminating device is housed in an electrical plug and wherein the output stage is configured to de-energize the illuminating element if the illuminating device is plugged into an electrical outlet.

11. The illuminating device according to claim 1, wherein the antenna is a prong of an electrical plug.

12. The illuminating device according to claim 11, wherein the illuminating device is housed in the electrical plug.

13. The illuminating device according to claim 10, wherein the output stage is configured to de-energize the illuminating element if the electrical plug is plugged into an electrical outlet.

14. The illuminating device according to claim 1, wherein the illuminating device is powered by a battery.

15. The illuminating device according to claim 10, wherein the illuminating device includes a grounding node to establish an electrical reference potential.

16. The illuminating device according to claim 15, wherein the grounding node is an electrical conductor of an electrical plug within which the illuminating device is housed.

17. The illuminating device according to claim 1, wherein the illuminating device includes a grounding node to establish an electrical reference potential.

18. The illuminating device according to claim 16, wherein the grounding node is an electrical conductor of an electrical plug within which the illuminating device is housed.

19. An illuminating device comprising:
an input circuit configured to sense an ambient electromagnetic field, said input circuit upon sensing an ambient electromagnetic field configured to generate an amplified AC voltage and a first output signal;
a signal discriminator coupled to said amplified AC voltage and said first output signal, said signal discriminator having an active state and an inactive state, said signal discriminator configured to transition from the inactive state to the active state upon receipt of said first output signal and when in said active state configured to determine characteristics of said AC voltage so that if the determined characteristics meet a predefined criterion, a second output signal is enabled; and
a drive circuit coupled to said second output signal, the drive circuit configured to control an illuminating device so as to cause said illuminating device to emit light when said second output signal is enabled.
